(19) United States
(12) Patent Application Publication
(10) Pub. No.: US 2021/0172224 A1
(43) Pub. Date: Jun. 10, 2021

(54) Telescoping handle doorstop wedge

(71) Applicant: Frederick Robert Ruby, La Quinta, CA (US)

(72) Inventor: Frederick Robert Ruby, La Quinta, CA (US)

(21) Appl. No.: 16/602,841

(22) Filed: Dec. 9, 2019

(51) Int. Cl. E05C 17/54; E05C 19/18

(52) U.S. Cl. CPC E05C 17/54; E05C 19/188

(57) ABSTRACT

This invention is a Telescoping Handle Doorstop Wedge, the light-weight high-quality aluminum handle of which can be closed-down or extended-up, stopping at any length between 9 inches and 38 inches. When extended, the Telescoping Handle Doorstop Wedge can be lengthened and custom adjusted to any person's comfortable/practical operating height, thus making it easy for the permanently-attached non-marking, non-skid, wide-footprint, oversized rubber doorstop wedge to be effortlessly inserted into or retracted from the space between the bottom edge of a hinged door and the floor below. The invention's non-stoop, no-muscle-strain benefits are obvious for persons such as those who are disabled, infirmed and elderly, or for other persons who cannot or simply do not prefer to bend or stoop so as to painlessly, effectively and accurately insert or release a doorstop wedge. This invention is balance-engineered, so that, when it is not in use, it will stand-alone and independent, thus it can be left standing and therefore stored or set aside in a convenient handy location while it remains adjusted to any personally-selected operational length. This invention is very unique, in that it can also be, for storage purposes, closed-down and folded into an overall product size of 9¾ inches long by 2¾ inches wide by 2¾ inches deep.

### BACKGROUND OF THE INVENTION

This invention is related to a doorstop for maintaining a door in a fixed open position, and more precisely, related to an insertable and retractable wedge shaped doorstop which is portable and incorporates an extendable and retractable telescoping permanent handle which allows the doorstop wedge to be employed without the user having to bear the aggravation of repeatedly bending down or stooping over.

There are predominantly examples of doorstop inventions that require the operator to bend or stoop to the floor in order to insert, by hand, a doorstop for the purpose of restraining a hinged door in a desired open position.

The necessity exists for a telescoping handle doorstop wedge, the handle of which, can be lengthened and custom adjusted to any person's comfortable/practical operating height thus making it easy for the attached doorstop wedge to be inserted into or retracted from a location between the bottom edge of the door and the floor below. The non-stoop benefits are obvious for those persons who are disabled, infirmed, elderly or for those who cannot or do not prefer to bend or stoop to insert or release a doorstop wedge.

### BRIEF SUMMARY OF THE INVENTION

Hinged doors, when standing open, have a natural inclination to inconveniently drift closed due to a variety of circumstances. Examples of such circumstances include door closing devices on door frames or hinges, gravity, drafts, wind, air conditioning circulation, atmospheric pressure-contrasts within a building and many others scenarios that could be listed.

It is therefore the primary objective of the invention to make easy the user's effort of propping open a hinged door, while the user remains standing in an upright position, and while the user is gripping the exactly extended, lightweight, telescoping handle with the doorstop wedge permanently attached to the opposite end from the handle-grip and then deploying the attached doorstop wedge to the floor and then proceeding to guide the attached doorstop wedge into the space between the bottom edge of the door and the floor without the necessity for the user to bend down or stoop over during the act of installation.

The telescoping length of the handle extends from a minimum of eight inches to a maximum of thirty-eight inches.

The invention works well with all types of floor surfaces, the likes of which include, but are not limited to tile, natural stone, metal, concrete, carpet, cork and vinyl.

The telescoping handle has a seven inch-long rubberized hand-grip which is wrapped around the largest diameter end of the telescoping handle. The doorstop wedge is securely attached to the smallest diameter end of the telescoping handle by a flexible primary coupling.

The telescoping handle includes several metal sections which nest together within the largest diameter end of the telescoping handle. Each telescoping section is cylindrical and of similar shape but they decrease in diametrical size as they progressively extend to the smaller diameter end of the telescoping handle. The sections nest inside each other which enables the telescoping handle to be shortened for storage or lengthened to the user's comfortable handheld height for doorstop wedge implementation.

The flexible primary coupling joins the doorstop wedge to the smallest diameter end of the telescoping handle. The flexible primary coupling has a center wheel that rolls forward and backward on an axle bolt which is a threaded metric stainless steel phillips pan machine screw, insuring that the forward and backward angle of the permanently attached doorstop wedge can be adjusted by the user, at any time, as much as 45 degrees in either the forward or backward direction, thus allowing the user of the doorstop wedge to insert it between the bottom door edge and the floor, on an approach of varying angles, thus customizing the doorstop wedge positioning. The flexible primary coupling is permanently attached to the smallest diameter end of the telescoping handle. The center wheel is nested in-between the flexible primary coupling's dual hub arms and is supported and secured by the axle bolt. The flexible primary coupling incorporates an anchor bolt head and its anchor bolt threaded member projecting from the flexible primary coupling's top-cap. The doorstop wedge is permanently connected to the telescoping handle via the anchor bolt threaded member. A hole exists through the rear top surface of the door stop wedge, and at the hole site, a threaded T-Nut is imbedded into the underside, rear, top surface of the doorstop wedge. The imbedded threaded T-nut allows for connection of the doorstop wedge to the anchor bolt threaded member and ultimately connects together the entire Telescoping handle doorstop wedge invention.

The doorstop wedge is made of long lasting, durable and strong but flexible rubber. The doorstop wedge is mostly hollow and has a flat base and flat non-slip-surface on its external sidewall bottom edges. The doorstop wedge incorporates three non-slip-surface internal reinforcing ribs positioned perpendicularly to the external sidewalls within its mostly hollow interior. The inclined external top surface of the doorstop wedge is six inches long and two & three-fourths of an inch wide and it inclines from a low point of one-eighth inch to a high point of two inches.

### BRIEF DESCRIPTION OF THE SEVERAL VIEWS OF THE DRAWINGS

The accompanying drawings help to understand the invention's features which have been described in the claims. The following descriptions are numbered and relate to the same numbered drawings that follow.

FIG. 1 is a three dimensional side view of the Telescoping handle doorstop wedge invention.

FIG. 2 is a three dimensional enlarged exploded view of the invention's flexible primary coupling.

FIG. 3 is a three dimensional view from the underside of the invention's rubber doorstop wedge.

FIG. 4 is a three dimensional side view of the invention with its telescoping handle in a fully collapsed and tilted (storage) position

CROSS-REFERENCE TO RELATED APPLICATIONS

| Publication | Priority | Publication | | |
|---|---|---|---|---|
| Number | Date | Date | Assignee | Title |
| U.S. Pat. No. 6,557,915B1 | 2000 Oct. 16 | 2003 May 6 | Duff's Door Stopper | Portable doorstop |
| | | | | with ergonomic |
| | | | | advantages |
| U.S. Pat. No. 5,217,269A | 1992 Sep. 8 | 1993 Jun. 8 | Wiltberger Charles M | Portable handled door |
| | | | | stop |
| U.S. Pat. No. 6,003,911A | 1996 May 31 | 1999 Dec. 21 | Michael Robert C. | Door stop |
| US20040256866A1 | 2003 Jun. 17 | 2004 Dec. 23 | Deming Robert F. | Straddling doorstop |
| | | | | with upright |
| U.S. Pat. No. 7,976,080B1 | 2007 Apr. 6 | 2011 Jul. 12 | Duff Robert O | Doorstop with |
| | | | | releasably securable |
| | | | | handle |
| US20130318882A1 | 2011 Feb. 8 | 2013 Dec. 5 | S & G Global Services | Door Assistant |
| | | | Pty Limited | |
| U.S. Pat. No. 4,142,752A | 1978 Feb. 21 | 1979 Mar. 6 | Chilton James O | Burglar entry stop |
| | | | | device |
| U.S. Pat. No. 1,939,402A | 1932 Sep. 6 | 1933 Dec. 12 | Byron W Moser | Doorstop |
| US20150054296A1 | 2013 Aug. 22 | 2015 Feb. 26 | Kevin Kaplafka, JR. | Portable access |
| | | | | prevention device |
| U.S. Pat. No. 4,494,784A | 1981 Dec. 7 | 1985 Jan. 22 | Haynes Harvey H | Door-stop for the |
| | | | | handicapped |

### DETAILED DESCRIPTION OF THE DRAWINGS

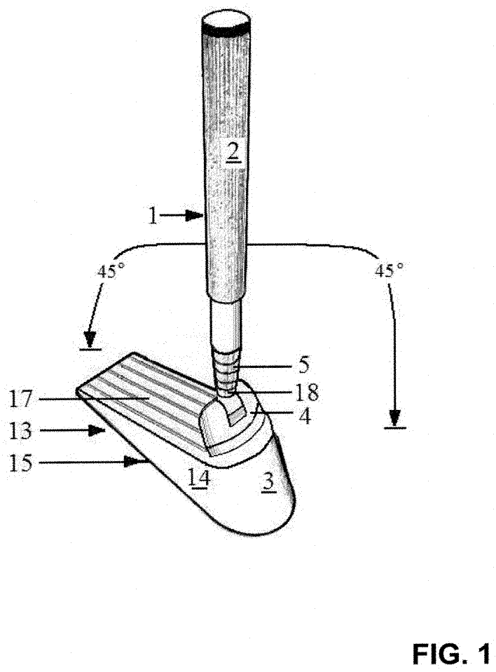

FIG. 1 is a three dimensional side view of the Telescoping handle doorstop wedge invention where.

The telescoping handle extends from a minimum of eight inches to a maximum of thirty eight inches.

The invention works well with all types of floor surfaces, the likes of which include but are not limited to tile, natural stone, metal, concrete, carpet, cork and vinyl.

The telescoping handle 1 has a seven inch-long rubberized hand-grip 2 which is wrapped around the largest diameter end of the telescoping handle 1. The doorstop wedge 3 is securely attached to the smallest diameter end 18 of the telescoping handle by a flexible primary coupling 4.

The telescoping handle 1 includes several metal sections 5 which nest together within the largest diameter end of the telescoping handle 1. Each telescoping section is cylindrical and of similar shape but they decrease in diametrical size as they progressively extend to the smaller diameter end 18 of the telescoping handle 1. The sections nest inside each other which enables the telescoping handle 1 to be shortened for storage or lengthened to the user's comfortable handheld height for doorstop wedge 3 deployment.

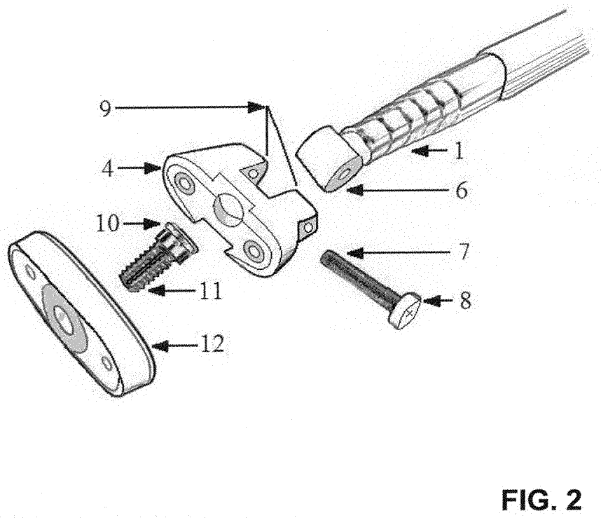

The flexible primary coupling 4 joins the doorstop wedge 3 to the smallest diameter end 18 of the telescoping handle 1. The flexible primary coupling 4 has a center wheel FIG. 2 that rolls forward and backward on an axle bolt FIG. 2 which is a threaded metric stainless steel phillips pan machine screw FIG. 2 insuring that the forward and backward angle of the permanently attached doorstop wedge 3 can be adjusted by the user, at any time, as much as 45 degrees FIG. 1 in either the forward or backward direction, thus allowing the user of the doorstop wedge 3 to insert it between the bottom door-edge and the floor, on an approach of varying angles, thus customizing the doorstop wedge 3 positioning under the bottom door-edge. The flexible primary coupling 4 is permanently attached to the smallest diameter end 18 of the telescoping handle 1. The center wheel FIG. 2 is nested in-between the flexible primary coupling's 4 dual hub arms FIG. 2 and is supported and secured by the axle bolt FIG. 2. The flexible primary coupling 4 incorporates an anchor bolt head FIG. 2 and an anchor bolt threaded member FIG. 2 projecting from the flexible primary coupling's 4 top-cap FIG. 2. The doorstop wedge 3 is permanently connected to the telescoping handle 1 via the anchor bolt threaded member FIG. 2. A hole exists through the rear top surface of the door stop wedge 3, and at the hole site, a threaded T-Nut is imbedded into and underside, rear, top surface of the doorstop wedge 3. The imbedded threaded T-nut allows for connection of the doorstop wedge 3 to the anchor bolt threaded member FIG. 2 and ultimately connects together the entire Telescoping handle doorstop wedge invention

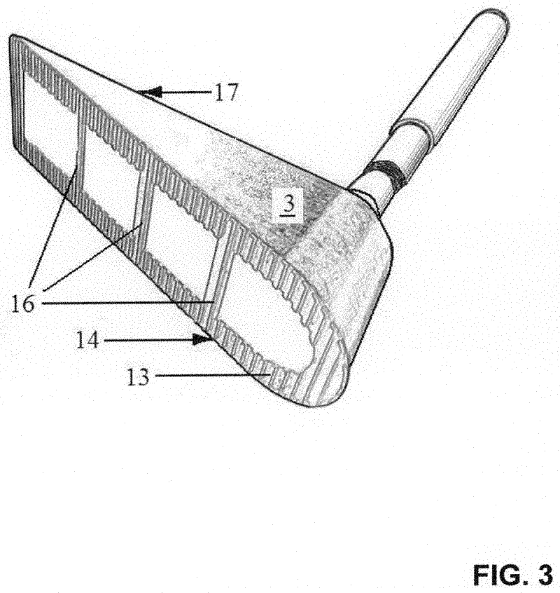

The doorstop wedge 3 is made of long lasting, durable and strong but flexible rubber. The doorstop wedge 3 is mostly hollow and has a flat base 13 and a flat non-slip-surface on its external sidewall 14 bottom edges 15. The doorstop wedge 3 incorporates three non-slip-surface internal reinforcing ribs FIG. 3 which are positioned perpendicularly to the external sidewalls, within its mostly hollow interior. The inclined external top surface 17 of the doorstop wedge 3 is six inches long and two & three-fourths of an inch wide and it extends from a low point of one-eighth inch to a high point of two inches.

FIG. 2 is a three dimensional exploded view of the invention's flexible primary coupling.

The flexible primary coupling 4 joins the doorstop wedge FIG. 1 to the smallest diameter end of the telescoping handle FIG. 1. The flexible primary coupling 4 has a center wheel 6 that rolls forward and backward on an axle bolt 7 and the attached axel bolt, which is a threaded metric stainless steel Phillips pan machine screw 8, insures that the forward and backward angle of the permanently attached doorstop wedge FIG. 1 can be adjusted by the user, at any time, as much as 45 degrees FIG. 1 in either the forward or backward direction, thus allowing the user of the doorstop wedge FIG. 1 to insert it in-between the bottom door edge and the floor, on an approach of varying angles, thus customizing the doorstop wedge FIG. 1 positioning. The flexible primary coupling 4 is permanently attached to the smallest diameter end FIG. 1 of the telescoping handle FIG. 1. The center wheel 6 is nested in between the flexible primary coupling's 4 dual hub arms 9 and is supported and secured by the axle bolt 7. The flexible primary coupling 4 incorporates an anchor bolt head 10 and an anchor bolt threaded member 11 projecting from the flexible primary coupling's 4 top-cap 12. The doorstop wedge FIG. 1 is permanently connected to the telescoping handle 1 via the anchor bolt threaded member 11. A hole exists through the rear top surface of the door stop wedge FIG. 1, and at the hole site, a threaded T-Nut is imbedded into and underside, rear, top surface of the doorstop wedge FIG. 1. The imbedded threaded T-nut allows for connection of the doorstop wedge FIG. 1 to the anchor bolt threaded member 11 and ultimately connects together the entire Telescoping handle doorstop wedge invention

FIG. 3 is a three dimensional view from the underside of the invention's doorstop wedge.

The doorstop wedge 3 is made of long lasting, durable and strong but flexible rubber. The doorstop wedge 3 is mostly hollow and has a flat base 13 and flat non-slip-surface on its external sidewall bottom edges 14. The doorstop wedge 3 incorporates three non-slip-surface internal reinforcing ribs 16, which are positioned perpendicularly to the external sidewalls, within its mostly hollow interior. The inclined external top surface 17 of the doorstop wedge 3 is six inches long and two & three-fourths of an inch wide and it inclines from a low point of one-eighth inch to a high point of two inches.

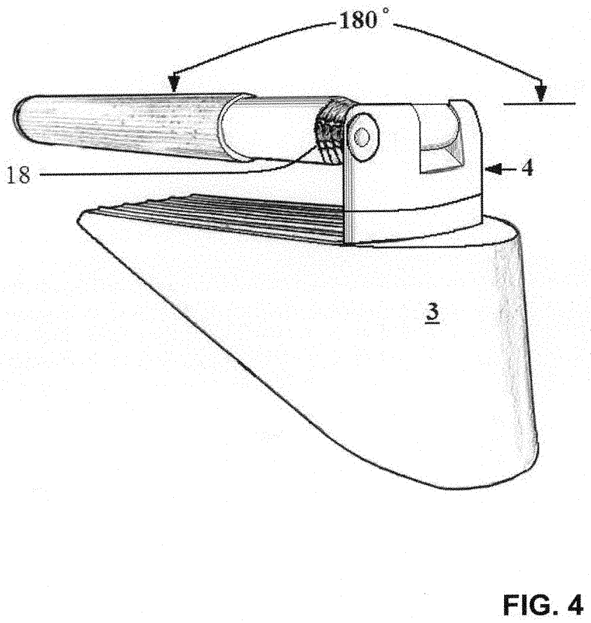

FIG. 4 is a three dimensional side view of the invention with its telescoping handle in a fully collapsed and tilted (storage) position.

The flexible primary coupling 4 joins the doorstop wedge 3 to the smallest diameter end 18 of the telescoping handle FIG. 1. The flexible primary coupling 4 has a center wheel FIG. 2 that rolls forward and backward on an axle bolt FIG. 2 that is a threaded metric stainless steel Phillips pan machine screw FIG. 2 which insures that the forward and backward angle of the permanently attached doorstop wedge 3 can be adjusted by the user, at any time, as much as 45 degrees FIG. 1 in either the forward or backward direction (180 degrees maximum) FIG. 4, thus allowing the user of the doorstop wedge 3 to insert it between the bottom door edge and the floor, on an approach of varying angles, thus customizing the doorstop wedge 3 positioning, or allowing the user to tilt the telescoping handle forward into a storage position with the telescoping handle fully collapsed or lengthened to the user's desire height.

1. A telescoping handle doorstop wedge, which is portable, and is used to maintain a hinged door in a wanted fixed open position
an extendable and retractable metal telescoping handle
a flexible primary coupling which is permanently attached to the smallest diameter end of the telescoping handle and which has a threaded member protruding from its top-cap surface.
an insertable and retractable, inclined rubber wedge, which is attached via the flexible primary coupling's threaded member.
an inclined rubber wedge which is permanently attached to the telescoping handle, and is deployed by the user into optimum position between the bottom edge of the door and the floor, without the user having to bend down or stoop over.

2. A Telescoping handle doorstop wedge according to claim 1, wherein the telescoping handle includes several metal sections which nest together within the largest diameter end of the telescoping handle.

3. A Telescoping handle doorstop wedge according to claim 2, wherein each telescoping handle section is cylindrical and of similar shape, and each decreases in diametrical size as it progressively extend to the smaller diameter end of the handle.

4. A Telescoping handle doorstop wedge according to claim 2, wherein a rubberized hand-grip is wrapped around the largest diameter end of the telescoping handle.

5. A Telescoping handle doorstop wedge according to claim 2, including a flexible primary coupling which is permanently fixed to the smallest diameter end of the telescoping handle.

6. A Telescoping handle doorstop wedge according to claim 5, including a primary flexible coupling which has a center wheel that rolls forward and backward on an axle bolt

7. A Telescoping handle doorstop wedge according to claim 6, including the center wheel of the flexible primary coupling, which incorporates an anchor bolt head and an anchor bolt threaded member projecting from the flexible primary coupling's top-cap.

8. A Telescoping handle doorstop wedge according to claim 7, including an inclined rubber doorstop wedge which is permanently connected to the smallest diameter end of the telescoping handle via the anchor bolt threaded member.

9. A Telescoping handle doorstop wedge according to claim 8, including a threaded T-nut which is imbedded into the underside, rear, top surface of the rubber doorstop wedge. The imbedded threaded T-nut allows for connection, through a hole in the rear, top surface of the rubber doorstop wedge, to the anchor bolt threaded member and ultimately completes final assembly of the entire Telescoping handled doorstop wedge invention.

10. A Telescoping handle doorstop wedge according to claim 9, including a doorstop wedge which is made of long lasting, durable and strong but flexible rubber. The doorstop wedge is mostly hollow and has a flat base and flat non-slip-surface on its external sidewall bottom edges. The doorstop wedge incorporates three non-slip-surface internal reinforcing ribs, which are positioned perpendicularly to the external sidewalls, within its mostly hollow interior.
